(19) United States
(12) Patent Application Publication
(10) Pub. No.: US 2014/0110603 A1
(43) Pub. Date: Apr. 24, 2014

(54) SCINTILLATOR PANEL AND METHOD OF MANUFACTURING THE SAME

(71) Applicant: ABYZR CO., LTD, Gyeonggi-do (KR)

(72) Inventors: Yun Sung HUH, Gyeonggi-do (KR); Tae Kwon HONG, Gyeonggi-do (KR); Gi Youl HAN, Chungcheongnam-do (KR)

(73) Assignee: ABYZR CO., LTD, Gyeonggi-do (KR)

(21) Appl. No.: 14/058,083

(22) Filed: Oct. 18, 2013

(30) Foreign Application Priority Data
Oct. 19, 2012 (KR) 10-2012-0116541

(51) Int. Cl. G01T 1/20

(52) U.S. Cl. CPC G01T 1/2002
USPC 250/488.1; 427/157; 204/192.1

(57) ABSTRACT

A scintillator panel includes a scintillator layer to be formed on an imaging device and an oxide layer on the scintillator layer to transmit an X-ray, reflect a visible light, and prevent moisture from being penetrated. The oxide layer has a structure including a number of oxide layers.

### CROSS-REFERENCE TO RELATED APPLICATIONS

This application claims the benefit under 35 U.S.C. Section 119 of Korean Patent Application Serial No. 10-2012-0116541, entitled filed Oct. 19, 2012, which is hereby incorporated by reference in its entirety into this application.

### BACKGROUND

1. Field

The present disclosure relates to a scintillator panel of a medical X-ray detecting device and a manufacturing method thereof, and more particularly, to a scintillator panel of a directly-deposited method to directly deposit a scintillator layer on an imaging device and a manufacturing method thereof.

2. Description of the Related Art

In the case of medical X-ray photography, the digital radiation imaging devices have been widely used to obtain an image using the radiation detectors without the use of the film and to display a photographed image by transmitting the image to a computer.

The digital radiation imaging devices can be classified into a direct conversion method and an indirect conversion method, the direct conversion method is a method to implement the images by directly converting the irradiated X-ray into an electric signal and the indirect conversion method is a method to implement the images after converting the X-ray into visible light and converting the visible light into the electric signal by using an imaging device such as a photodiode, a CMOS and a CCD sensor or the like. Since the direct conversion method can perform the detection only when a high voltage is applied, the indirect conversion method has been widely used.

In the case of the indirect conversion method, it utilizes a scintillator to convert the X-ray into the visible light and is classified into a direct method and an indirect method according to a method of integrating the scintillator and the imaging device. The direct method is to directly deposit the scintillator layer on the imaging device and the indirect method is to manufacture a scintillator panel obtained by depositing the scintillator layer on a substrate first and to attach it to the imaging device panel by using an adhesive.

In the published patent 10-2011-0113482 (METHOD FOR MANUFACTURING RADIATION IMAGE SENSOR BY DIRECT DEPOSITION METHOD), the directly-deposited scintillator panel structure is disclosed.

In viewing of the scintillator panel of the conventional direct method, it includes a protection layer to protect a scintillator layer from the moisture and the protection layer should include parylene films. For example, they are a single layer structure formed with only the parylene film, double layer structure formed with a first parylene film and a second parylene film and a triple layer structure formed with a first parylene film, an inorganic film and a second parylene film or the like.

As like this, a polymer based material such as a polyparaxylylene film or a parylene film is included as a protection film of a conventional scintillator layer, the polymer based material is easily destructed when the ray of high energy such as UV and X-ray or the like as well as the performance of the products may be deteriorated as the polymer based protection layer is gradually aged. And also, since the polymer based material plays a role of weakening intensity of the visible light, it causes to deteriorate the resolution of data to be displayed. Particularly, in order to increase the resolution or the like, in case when the intensity of the X-ray is increased, it retrogresses to the function as the medical device. Accordingly, it is required to prepare an optical and technical means to receive the visible light generated from the scintillator as much as possible.

Also, since the conventional direct-deposited scintillator panel additionally is provided with a reflection layer for reflecting the visible light generated in the scintillator layer to the direction of the imaging device, it has a problem that its structure is complex.

### SUMMARY

The present disclosure has been achieved in order to improve the structure of the scintillator according to such conventional direct-deposited method and it is, therefore, a first object of the present disclosure to simplify the structure, a second object of the present disclosure not to be provided with a reflective layer additionally, a third object of the present disclosure to control the characteristics of reflection or transmission freely and a fourth object of the present disclosure to reduce the manufacturing cost through the simplification of the structure and manufacturing processes.

The scintillator panel of the direct method to achieve the above-described objects includes a scintillator layer and an oxide layer.

The scintillator layer is formed on an imaging device.

The oxide layer is formed on the scintillator layer to transmit the X-ray, reflect the visible light and prevent the moisture from being penetrated.

In the scintillator panel of the direct method according to some embodiments of the present invention, the oxide layer is a structure obtained by depositing a first oxide layer having a refractive index from 1.0 to 2.0 and a second oxide layer having a refractive index from 2.0 to 3.0. Herein, the first oxide layer is a SiO₂ layer and the second oxide layer is TiO₂ layer. And, oxide layer having the refractive index near to that of the scintillator layer is deposited on the scintillator layer at first.

In the scintillator panel of the direct method according to some embodiments of the present invention, a protection layer deposited on the oxide layer for transmitting the X-ray and preventing the moisture from being penetrated is further included.

The method for manufacturing the scintillator panel of the direct method according to some embodiments of the present invention includes the steps of forming a scintillator layer on an imaging device; and forming an oxide layer on the scintillator layer for transmitting an X-ray, reflecting visible light, and preventing moisture from being penetrated.

In the method for manufacturing the scintillator panel of the direct method according to some embodiments of the present invention, forming the oxide layer repeats the following steps many times: forming a first oxide layer having a refractive index from 1.0 to 2.0; and forming a second oxide layer having a refractive index from 2.0 to 3.0. Herein, the first oxide layer is a SiO₂ layer and the second oxide layer is TiO₂ layer. And, in forming the oxide layer, the oxide layer having the refractive index near to that of the scintillator layer is deposited on the scintillator layer at first.

In the method for manufacturing the scintillator panel of the direct method according to some embodiments of the present invention, forming the oxide layer utilizes a sputtering with a process pressure from several tens to several hundreds of mTorr, an ion auxiliary vacuum deposition with a process pressure below 10⁻⁵ Torr or a substrate inclination revolution/rotation method.

In the method for manufacturing the scintillator panel of the direct method according to some embodiments of the present invention, a step of forming a protection layer on the oxide layer for transmitting the X-ray and preventing the moisture from being penetrated is further included.

### BRIEF DESCRIPTION OF THE DRAWINGS

FIG. 1 is a cross-sectional view showing a directly-deposited scintillator panel having a monolayer oxide layer according to some embodiments of the present invention;

FIG. 2A is a cross-sectional view showing a directly-deposited scintillator panel having a multi-layer oxide layer according to some embodiments of the present invention;

FIG. 2B is a graph showing a reflection property of the oxide layer in the directly-deposited scintillator panel according to some embodiments of the present invention;

FIG. 3 is a flowchart showing a method for manufacturing a directly-deposited scintillator panel according to some embodiments of the present invention;

FIG. 4A is a cross-sectional view showing a directly-deposited scintillator panel having a protection layer according to some embodiments of the present invention; and

FIG. 4B is a flowchart showing a method for manufacturing a directly-deposited scintillator panel having the protection layer of FIG. 4A.

### DETAILED DESCRIPTION OF THE PREFERABLE EMBODIMENTS

Exemplary embodiments of the present invention to achieve the above-described objects will be described with reference to the accompanying drawings. In this description, the same elements are represented by the same reference numerals, and additional description which is repeated or limits interpretation of the meaning of the invention may be omitted.

FIG. 1 is a cross-sectional view showing a directly-deposited scintillator panel having a monolayer oxide layer according to some embodiments of the present invention.

As shown in FIG. 1, the directly-deposited scintillator panel 200 includes a scintillator layer 210 deposited on a top surface of an imaging device 100 and an oxide layer 220 stacted on the scintillator layer 210.

The imaging device 100 includes a substrate 110, a plurality of light receiving elements 120, a plurality of electrode pads 130 or the like. The light receiving elements 120 are arranged on a center of a surface of the substrate and the electrode pads 130 are arranged at a peripheral region of the surface of the substrate 110.

The light receiving elements 120 is a photoelectric conversion device formed on the substrate 110 made of silicon or glass by being arranged in one dimension or two dimensions. The light receiving elements 120 detects a visible light converted by the scintillator layer 210 and converts it into an electric signal. The light receiving elements 120 may be a photodiode or a thin film transistor or the like.

The electrode pads 130 are formed on the peripheral regions of the surface of the substrate 110 in plural. The electrode pads 130 reads the electric signal generated by the light receiving elements 120 and transmits it to an image analyzing apparatus or the like. The electrode pads 130 are electrically connected to the light receiving elements 120 through a wire or the like.

The scintillator layer 210 is formed on a top portion of the imaging device 100 and, in some embodiments of the present invention, the scintillator layer 210 covers a whole surface on which the light receiving element 120 is formed and the peripheral region thereof. The scintillator layer 210 is deposited in a structure of a column shape. Each column structure has a sharp shape toward a top portion without being flat in the top portion. The thickness of the scintillator layer 210 is in the degree of approximately 20˜200 pm. The scintillator layer 210 converts the incident radiation ray into the visible light which can be detected by the light receiving element 120.

The scintillator layer 210 is not limited in its type if it can convert the radiation ray into the visible light. For example, CsI, CsI doped with thallium (TI), CsI doped with natrium (Na) and NaI doped with thallium (TI) or the like can be utilized. Among those, in some embodiments of the present invention, the CsI doped with thallium (TI) is utilized, since it emits the visible light and has excellent light emission efficiency.

Since the CsI forming the scintillator layer 210 is a hygroscopic material, it melts if absorbs the moisture in the air. That is, if the moisture is in contact with the scintillator layer 210, the scintillator layer 210 is damaged to thereby degrade the resolution of the image obtained from the imaging device 100. Accordingly, it is very important to prevent the scintillator layer 210 from being in contact with the moisture.

The oxide layer 220 is formed on the scintillator layer 210. The oxide layer 220 protects the scintillator layer 210 from the moisture by blocking the penetration of moisture. And also, the oxide layer 220 transmits the radiation ray and reflects the visible light converted from the scintillator layer 210 to a direction of the imaging device 100. By doing so, the resolution obtained from the imaging device 100 can be improved.

The oxide layer 220 is consisting of an oxide layer such as a metal. For example, SiO₂ or TiO₂ or the like can be utilized.

The oxide layer 220 can be formed by using a physical vapor deposition such as an electron beam deposition, a sputtering and a thermal evaporation or a chemical vapor deposition or the like. In some embodiments of the present invention, since the whole surface of the scintillator layer 210 is deposited with the oxide layer 220, the oxide layer 220 is deposited on the scintillator layer 210 with a high pressure sputtering method having excellent step coverage. The process pressure of the high pressure sputtering is ranged from several tens to several hundreds of mTorr.

The oxide layer 220 can be formed to reflect a specific wavelength range among the visible light. The visible light has a wavelength bandwidth from 400 to 700 nm, it is classified into a blue region having a wavelength range from 400 to 500 nm, a green region having a wavelength range from 500 to 600 nm and a red region having a wavelength range from 600 to 700 nm. But, the light receiving element 120 cannot receive the full bandwidth of the visible light according to the degree of depth that the light receiving element 120 is formed in the substrate 110. For example, if the light receiving element 120 is formed in the substrate 110 to a depth of 4 to 5 μm, the light receiving element 120 can detect the lights of blue region and green region, but the light receiving element 120 cannot detect the light of red region having a bandwidth of 600 to 700 nm. Accordingly, since the wavelength bandwidth of the visible light to be reflected is determined according to the formation depth of the light receiving element 120, the formation depth can be formed to maximize the reflectivity in the effective reflection bandwidth when the oxide layer is formed.

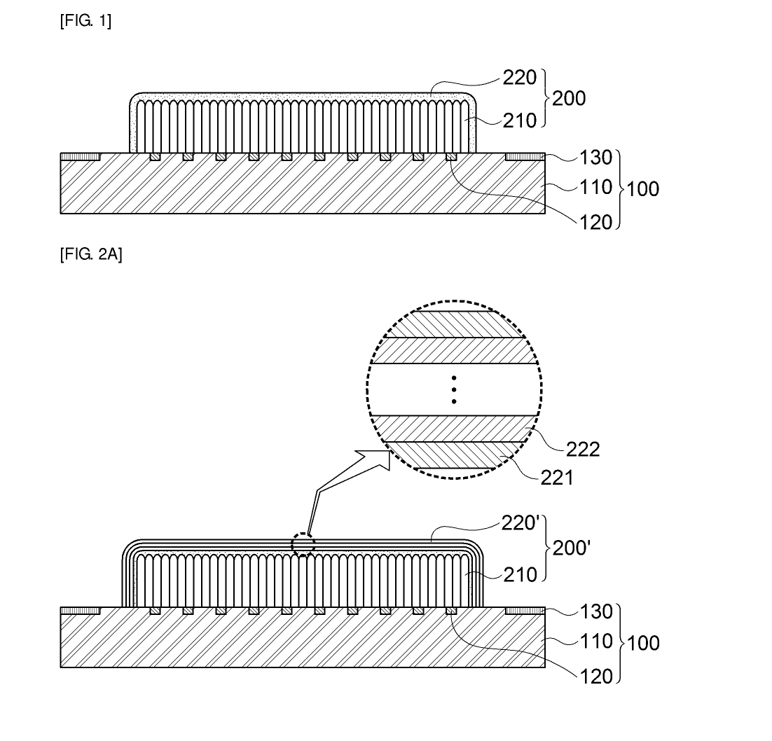

FIG. 2A is a cross-sectional view showing a directly-deposited scintillator panel having a multi-layer oxide layer according to some embodiments of the present invention.

As shown in FIG. 2A, the oxide layer 220′ can be formed by depositing a plurality of oxide layers having different refractivity from each other. As shown in FIG. 1, if the oxide layer 220 is formed with a single layer, it cannot obtain sufficient reflectivity. In this case, if the plurality of oxide layers 221 and 222 are deposited and the type or the number of the deposited oxide layers 221 and 222 is controlled, the reflectivity which cannot be obtained from the oxide layer 220 formed of the single layer can be obtained.

In case when the oxide layer 220′ is formed with two oxide layers 221 and 222 having two refractive indexes different from each other, the reflectivity R may be represented as the following mathematical equation 1,

$$\vert R = \frac{{( n 1 - n 2 )}^{2}}{{( n 1 + n 2 )}^{2}} \vert . \qquad Mathematical Eq . 1$$

wherein the R is the reflectivity.

For example, the oxide layer 220′ can be formed by depositing a number of first oxide layers 221 and the second oxide layers 222, wherein a material having the reflectivity from 1.0 to 2.0 is selected as the first oxide layer 221 and a material having the reflectivity from 2.0 to 3.0 is selected as the second oxide layer 222. That is, in case when the first oxide layer 221 is formed with a SiO₂ film and the second oxide layer 222 is formed with a TiO₂ film, since the refractive index of the SiO₂ film is about 1.4 and the refractive index of the TiO₂ film is about 2.5, the reflectivity is calculated as 8%. But, the reflectivity of 8% is not satisfied. In this case, if a plurality of SiO₂ films and TiO₂ films, e.g., 2˜31 layers, are deposited with different thicknesses from each other, it can obtain the reflectivity above 90% at broad wavelength bandwidth and it can be called as a cut-off filter.

And also, when forming with a plurality of oxide layers 220′, the type, the number of depositing, the thickness of the oxide layers 221 and 222 can be controlled so as to maximize the effective reflectivity of the visible light according to the installation depth of the light receiving element 120.

FIG. 2B is a graph showing a reflection property of the oxide layer in the directly-deposited scintillator panel according to some embodiments of the present invention.

As shown in FIG. 2B, the oxide layer 220′ reflects almost 100% of the visible light bandwidth from 300 to 600 nm, and transmits almost 100% of the light of the other region. The filter characteristics of the oxide layer as shown in FIG. 2B can be obtained by controlling the type, the depositing number and the thickness of the plurality of oxide layers having different refractive indexes.

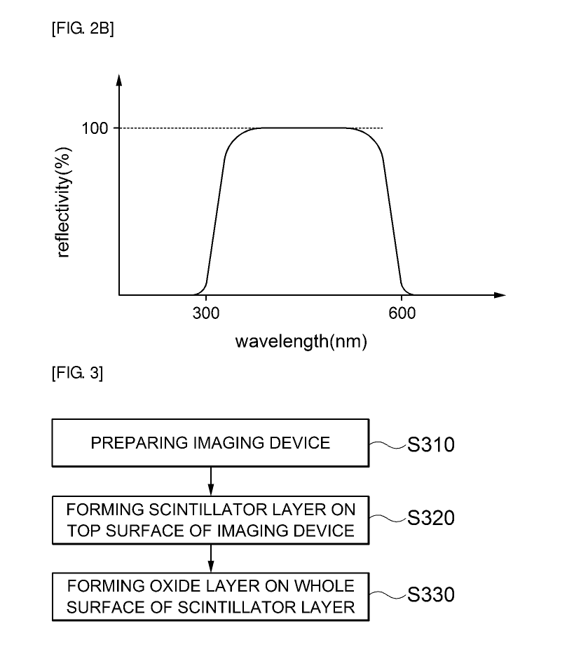

FIG. 3 is a flowchart showing a method for manufacturing a directly-deposited scintillator panel according to some embodiments of the present invention.

As shown in FIG. 3, the imaging device 100 on which the light receiving elements 120 and the electrode pads 130 are formed is inserted to support (S310).

In the deposition chamber, the scintillator layer 210 is deposited on the surface on which the light receiving elements 120 are formed (S320). At this time, the scintillator layer 210 is deposited over an area wider than an area on which the light receiving elements 120 are formed.

Since the upper most stage of the scintillator layer 210 has crystals having different heights from each other, the step coverage should be good when the oxide layers 220 and 220′ are deposited on the scintillator layer 210. In some embodiments of the present invention, the deposition process of the oxide layers 220 and 220′ is a physical vapor deposition (PVD), wherein the PVD can be an evaporation method or a sputtering method.

In case when the oxide layers 220 and 220′ are formed by applying the evaporation method, since the process is performed under a pressure below 10⁻⁵ Torr, the evaporated materials are incident on the surface of the substrate 110, on which the light receiving elements 120 are placed, with an almost rectilinear movement. Accordingly, in order to improve the step coverage of the oxide layers 220 and 220′, so-called substrate inclination revolution/rotation method, that is, the angle between the surface of the substrate 110, on which the light receiving elements 120 are placed, and the evaporation materials to be incident on the surface of the substrate 110 is ranged from 0 to 45 degrees, and the method to deposit with revolving/rotating can be utilized. For this, an apparatus provided with a substrate supporting unit in a shape of dome is required.

And also, when the oxide layers 220 and 220′ are deposited by the evaporation method, in order to improve the compactness of the oxide layers 220 and 220′, an ion beam assisted deposition (IBED) can be utilized.

When the oxide layers 220 and 220′ are evaporated by using the sputtering method, since the process pressure is much higher than that of the evaporation method, the target materials to be sputtered and reached at the substrate can be deposited with various incidence angles. Accordingly, although an additional substrate support apparatus is not used in the sputtering method, the step coverage is excellent. In this case, after the imaging device 100 formed thereon the scintillator layer 210 is moved to the sputtering chamber, the oxide layers 220 and 220′ are formed under the high process pressure from several tens to several hundreds of mTorr.

When the oxide layer 220′ is deposited by the evaporation method or the sputtering method, the layer is formed by sequentially and alternately depositing an oxide layer of a first material having a refractive index from 1.0 to 2.0 and an oxide layer of a second material having a refractive index from 2.0 to 3.0. At this time, the oxide layer which is in contact with the scintillator layer 210 may be the first material or the second material. Merely, the material having the refractive index close to that of the scintillator layer 210 can be deposited first. When the oxide layer 220′ is formed by depositing 2˜31 number of layers, the thickness of each oxide layer can be controlled so as to optimally reflect the ray of visible region generated in the scintillator layer 210 at the oxide layer 220′ and the number of the whole deposited oxide layers can be controlled.

The top surface of the scintillator layer 210 is sealed by the oxide layers 220 and 220′ and the side surface thereof is also sealed. In this result, the oxide layer 220 transmits the X-ray incident to the scintillator layer 210 almost 100%, reflects the visible light converted in the scintillator layer 210 almost 100% in the direction of the imaging device 100 and also can protect the scintillator layer 210 by preventing the moisture from being penetrated.

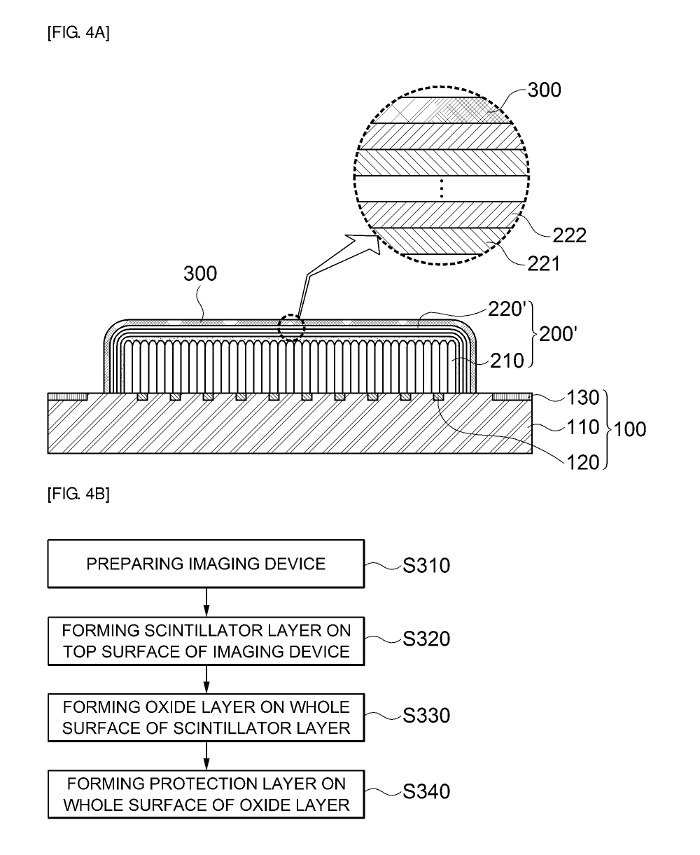

FIG. 4A is a cross-sectional view showing a directly-deposited scintillator panel having a protection layer according to some embodiments of the present invention.

As shown in FIG. 4A, in the directly-deposited scintillator panel according to some embodiments of the present invention, a protection layer 300 can be further formed on the oxide layer 220. If the X-ray is transmitted and the moisture is blocked, the material to form the protection layer 300 is not limited. For example, an organic resin, specifically parylene resin, can be used. As the parylene is the proprietary name of the chemically deposited poly p-xylene polymer, it includes parylene N, parylene C, parylene D, and parylene AF-4 or the like, and the coating film of the parylene has small penetration of the moistures or the gases, high water repellency and chemical resistance, excellent electric insulation, and also can transmit the radiation.

The protection layer 300 can be deposited by a physical vapor deposition (PVD) or a chemical vapor deposition (PVD) or the like.

FIG. 4B is a flowchart showing a method for manufacturing a directly-deposited scintillator panel having the protection layer of FIG. 4A.

The manufacturing method of FIG. 4B further includes a step of forming the protection layer 300 on the oxide layer 220 in comparison with the manufacturing method of FIG. 3 (S340). The protection layer 300 is formed by depositing the parylene or the like in the deposition chamber.

According to some embodiments of the present invention having such constructions and steps, since the oxide layer performs the protection function and the reflection function in the structure of the scintillator panel at the same time, it is not required to the reflective film separately. In this result, it can be easily manufactured and the cost can be reduced. Also, since the reflection or transmission characteristics can be controlled according to the depositing number of the oxide layers, the scintillator panel having the desired reflection characteristics can be manufactured.

The above-described embodiments and the accompanying drawings are provided as examples to help understanding of those skilled in the art, not limiting the scope of the present disclosure. Further, embodiments according to various combinations of the above-described components will be apparently implemented from the foregoing specific descriptions by those skilled in the art. Therefore, the various embodiments of the present invention may be embodied in different forms in a range without departing from the essential concept of the present disclosure, and the scope of the present disclosure should be interpreted from the subject matter recited in the claims. It is to be understood that the present disclosure includes various modifications, substitutions, and equivalents by those skilled in the art.

1. A scintillator panel, comprising:
a scintillator layer to be formed on an imaging device; and
an oxide layer formed on the scintillator layer and configured to transmit an X-ray, reflect visible light, and prevent moisture penetration.

2. The scintillator panel according to claim 1, wherein the oxide layer is a structure including a first oxide layer having a refractive index from 1.0 to 2.0 and a second oxide layer having a refractive index from 2.0 to 3.0.

3. The scintillator panel according to claim 2, wherein
the first oxide layers are SiO₂ layers and the second oxide layers are TiO₂ layers, and
a number of layers in the structure is from 2 to 31.

4. The scintillator panel according to claim 2, wherein the first oxide layer or the second oxide layer having the refractive index closer to that of the scintillator layer is formed on the scintillator layer first.

5. The scintillator panel according to claim 1, further comprising a protection layer formed on the oxide layer and configured to transmit the X-ray and prevent the moisture penetration.

6. A method of manufacturing a scintillator panel, the method comprising:
forming a scintillator layer on an imaging device; and
forming an oxide layer on the scintillator layer, the oxide layer being configured to transmit an X-ray, reflect visible light and preventing moisture penetration.

7. The method according to claim 6, wherein the forming an oxide layer includes
forming a first oxide layer having a refractive index from 1.0 to 2.0; and
forming a second oxide layer having a refractive index from 2.0 to 3.0.

8. The method according to claim 7, wherein
the first oxide layer is a SiO₂ layer and the second oxide layer is TiO₂ layer, and
a number of layers in the oxide layer is from 2 to 31.

9. The method according to claim 7, wherein, in the forming an oxide layer, the first oxide layer or the second oxide layer having the refractive index closer to that of the scintillator layer is formed on the scintillator layer first.

10. The method according to claim 6, wherein the forming an oxide layer includes sputtering with a process pressure from several tens to several hundreds of mTorr.

11. The method according to claim 6, wherein the forming an oxide layer includes sputtering with an ion auxiliary vacuum deposition with a process pressure below 10⁻⁵ Torr.

12. The method according to claim 6, wherein the forming an oxide layer includes sputtering with a substrate inclination revolution/rotation method.

13. The method according to claim 10, further comprising forming a protection layer on the oxide layer, the protection layer configured to transmit the X-ray and prevent the moisture penetration.

14. The method according to claim 11, further comprising forming a protection layer on the oxide layer, the protection layer configured to transmit the X-ray and prevent the moisture penetration.

15. The method according to claim 12, further comprising forming a protection layer on the oxide layer, the protection layer configured to transmit the X-ray and prevent the moisture penetration.
